(19) United States
(12) Patent Application Publication
(10) Pub. No.: US 2025/0381726 A1
(43) Pub. Date: Dec. 18, 2025

(54) POLYMER SUBSTRATE PLATE HAVING AN IMITATING NATURAL MATERIAL SURFACE AND MANUFACTURING METHOD THEREOF

(71) Applicant: Chen Fa Resources Technology Development Co., Ltd., Kaohsiung (TW)

(72) Inventor: CHING-TING YEH, Kaohsiung (TW)

(21) Appl. No.: 19/190,462

(22) Filed: Apr. 25, 2025

(30) Foreign Application Priority Data
Jun. 17, 2024 (TW) 113122386

(51) Int. Cl. B29C 59/00; B29C 48/00; B29C 48/03; B29K 105/00; B29K 105/16; B29K 105/20; B29K 507/04; B29K 509/08

(52) U.S. Cl. CPC B29C 59/002; B29C 48/0012; B29C 48/03; B29K 2105/0005; B29K 2105/0073; B29K 2105/16; B29K 2105/206; B29K 2507/04; B29K 2509/08

(57) ABSTRACT

A manufacturing method for a polymer substrate plate includes: prefabricating at least one lightweight polymer material selected from a plastic material, a rubber material or combination thereof; prefabricating at least one solvent selected from a single solvent or a mixed solvent; mixing and stirring the lightweight polymer material with the solvent at room temperature to obtain a mixed polymer material; extrusion forming and hardening the mixed polymer material to form at least one imitating material-pattern surface having at least one imitating material pattern to obtain an imitating material-pattern colloidal plate.

### BACKGROUND OF THE INVENTION

### 1. Field of the Invention

The present invention relates to a polymer substrate plate having an imitating (faux) natural material-pattern surface and a manufacturing method thereof. Particularly, the present invention relates to a room-temperature-processed polymer substrate plate having an imitating natural material-pattern surface and a manufacturing method thereof.

### 2. Description of the Related Art

Taiwanese Patent Publication No. TW-390375, entitled “Improvement of imitating stone plate structure,” discloses an imitating stone plate structure. The imitating stone plate structure is formed as a square plate, a rectangular plate, a rhombus plate, a polygonal plate or a circular plate, with the imitating stone plate structure having a top layer, an intermediate layer and a bottom layer.

As described above, the intermediate layer is a plastic plate having a poor degree of flexibility. The intermediate layer includes a top surface and a bottom surface each of which having a coarse grained pattern surface. Furthermore, the top layer and the bottom layer are made of plastic powder material added with calcium carbonate powder, with the plastic powder material further mixing with hardener and adhesive.

As described above, the intermediate layer is previously fixed in a molding device and a thick liquid material is further injected on the top surface and the bottom surface on which to be pressured to form the top layer and the bottom layer. Furthermore, the bottom layer has a bottom surface on which to form a plurality of protruded ribs to produce an imitating stone plate structure.

Another Taiwanese Patent Publication No. TW-M292606, entitled “Easy assembly imitating stone plate,” discloses an imitating stone plate formed from a rectangular foamed hardened plate. The imitating stone plate has a front layer performed as an imitating stone portion and a rear layer performed as an extension assembly portion.

As described above, the imitating stone portion has a surface formed with a plurality of irregular concave and convex imitating stone patterns, with the extension assembly portion having two adjacent edges of corner each of which extends outward to form an extension plate. Each extension plate has an outer peripheral edge which has a tenon beveled surface.

As described above, the extension assembly portion has another two adjacent edges of corner each of which forms a recessed groove to correspondingly receive the extension plate. Each of recessed grooves has an inner peripheral edge which has a beveled surface to correspondingly engage with the tenon beveled surface of extension plate.

Another Taiwanese Patent Publication No. TW-M398003, entitled “Fireproof decoration plate with imitating stone-plate material,” discloses a fireproof decoration plate with imitating stone-plate material including a substrate and a facial layer. The substrate is made of a calcium silicate plate while the facial layer is formed by coating.

As described above, the facial layer has a plurality of imitating stone particles, with the imitating stone particles adhered and fixed to the substrate with an adhesive so as to form an imitating stone pattern layer. The facial layer is formed on the substrate by spraying, with the facial layer further comprising a gloss varnish layer formed thereon.

Another Taiwanese Patent Publication No. TW-M561000, entitled “Improvement of imitating stone plate structure,” also discloses an imitating stone laminate structure. The imitating stone laminate structure comprises a surface layer and a bottom layer, with the surface layer comprising a plastic cover, at least one stone-imitating grain color pigment and a polyester epoxy, with the bottom layer comprising a base material. Furthermore, the base material is formed from a fiber plate, a fiber-reinforced plastic plate, an ABS plate, a wooden plate, a glass-reinforced plastic plate or an acrylic plate.

As described above, the imitating stone laminate structure further comprises a support layer, including a silica sand material, a fiber-glass material and an epoxy material which are mixed and compacted between the surface layer and the bottom layer by molding. Furthermore, the imitating stone laminate structure laterally extends to form a lateral structure.

Another Taiwanese Patent Publication No. TW-1611079, entitled “Manufacturing method of plastic floor plates with imitating wooden/stone surfaces,” also discloses a manufacturing method of plastic floor plates with imitating wooden/stone surfaces. The method comprises: fabricating a PVC slice substrate with a PVC powder, a thermal stabilizer agent, an anti-aging agent, a pigment and a filling material, with further adding a plurality of emery particles to form various flow patterns in a calendering process.

As described above, the method further comprises: adhering the PVC slice substrate with a pattern-grained panel layer and a pattern-grained bottom layer to form a semi-finished product; polishing both side surfaces of the semi-finished product with a polishing machine.

As described above, the method further comprises: roll-coating the both side surfaces of the semi-finished product to form a coating layer thereon with a roller coating machine, with removing the coating layer to obtain an imitating wooden pattern or an imitating stone pattern, with further coating the both side surfaces of the semi-finished product to form a top finishing coat layer and a bottom finishing coat layer with a UV-curable material and tempering the top finishing coat layer and the bottom finishing coat layer.

As described above, the plastic floor plate further comprises a plurality of glass fiber layers, with stacking the plurality of glass fiber layers with the plastic floor plate in a staggered arrangement so as to provide a functional degree of stability of products.

However, there is a need of improving the conventional imitating materials, structures, or manufacturing methods with heating and melting polymer materials. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide a polymer substrate plate having an imitating (faux) natural material surface and a manufacturing method thereof. A lightweight polymer material is selectively prefabricated with plastic, rubber or both while a solvent is prefabricated with a ratio of single solvent to mixed solvent to provide various material characteristics and functions according to needs. The lightweight polymer material with the solvent is mixed and stirred at room temperature to obtain a mixed (dissolved) polymer material, with extrusion forming and hardening the mixed polymer material to form at least one imitating material-pattern surface having at least one imitating material pattern to obtain an imitating material-pattern colloidal plate. Advantageously, the polymer substrate plate and the manufacturing method of the present invention are successful in mixing and grafting polymers at room temperature to avoid plastic granulation and to efficiently recycle waste materials in recovery.

The polymer substrate plate in accordance with an aspect of the present invention includes:
at least one lightweight polymer material selected from a plastic material, a rubber material or combination thereof;
at least one solvent selected from a single solvent or a mixed solvent;
a mixed polymer material formed as a dissolved polymer material by mixing and stirring the lightweight polymer material with the solvent at room temperature;
an imitating material-pattern colloidal plate formed by extrusion forming and hardening the mixed polymer material to obtain at least one imitating material-pattern surface; and
at least one imitating material pattern formed on the at least one imitating material-pattern surface provided on the imitating material-pattern colloidal plate.

In a separate aspect of the present invention, the imitating material-pattern surface is selected from an imitating sedimentary rock surface, an imitating granite surface, an imitating marble surface, an imitating dolomite surface, an imitating wooden board plate, an imitating bamboo board plate or combinations thereof.

In a further separate aspect of the present invention, the imitating material-pattern colloidal plate has at least one assembling surface, at least one assembling block or at least one assembling portion.

In yet a further separate aspect of the present invention, the imitating material-pattern colloidal plate is selected from an imitating stone furniture plate, an imitating stone decoration plate, an imitating stone board plate, an imitating stone panel plate, an imitating stone floor plate, an imitating stone brick plate, an imitating wooden board plate, an imitating bamboo board plate or combinations thereof.

In yet a further separate aspect of the present invention, the imitating material-pattern colloidal plate is performed as an imitating material semi-finished plate.

In yet a further separate aspect of the present invention, the plastic material is selected from plastic (or waste plastic) fragment materials, plastic (or waste plastic) slice materials, plastic (or waste plastic) powder materials or combinations thereof.

In yet a further separate aspect of the present invention, the rubber material is selected from rubber (or waste rubber) fragment materials, rubber (or waste rubber) slice materials, rubber (or waste rubber) powder materials or combinations thereof.

In yet a further separate aspect of the present invention, the plastic material or the rubber material is selected from a solvent-soluble material, an organic-solvent-soluble material or combination thereof.

In yet a further separate aspect of the present invention, the mixed polymer material is added with at least one functional material.

In yet a further separate aspect of the present invention, the at least one functional material is selected from a foaming material, a foaming aid agent material, a processing agent material, a fireproof material, a pigment material or combinations thereof.

The manufacturing method of the polymer substrate plate in accordance with another aspect of the present invention includes:
prefabricating at least one lightweight polymer material selected from a plastic material, a rubber material or combination thereof;
prefabricating at least one solvent selected from a single solvent or a mixed solvent;
mixing and stirring the lightweight polymer material with the solvent at room temperature to obtain a mixed polymer material as a dissolved polymer material; and
extrusion forming and hardening the mixed polymer material to form at least one imitating material-pattern surface having at least one imitating material pattern to obtain an imitating material-pattern colloidal plate.

In a separate aspect of the present invention, the imitating material-pattern colloidal plate further includes at least one glass fiber material or at least one carbon fiber material.

In a further separate aspect of the present invention, the at least one glass fiber material or the at least one carbon fiber material is formed with at least one mesh fiber layer.

In yet a further separate aspect of the present invention, the imitating material-pattern colloidal plate is provided as an imitating material semi-finished plate which is further processed in a foaming procedure to obtain a foamed imitating material-pattern colloidal plate.

In yet a further separate aspect of the present invention, the imitating material-pattern colloidal plate is provided as an imitating material semi-finished plate which is further processed in a foaming procedure with a softener agent to obtain a softened imitating material-pattern colloidal plate.

In yet a further separate aspect of the present invention, the at least one solvent is provided to dissolve at least one part of the plastic material or the rubber material to form at least one polymer colloid.

In yet a further separate aspect of the present invention, the at least one polymer colloid is provided to adhere and graft among the plastic material, the rubber material or both.

In yet a further separate aspect of the present invention, the imitating material-pattern colloidal plate has an extruded 3D surface.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a polymer substrate plate having an imitating (faux) natural material-pattern surface in accordance with a preferred embodiment of the present invention.

FIG. 2 is a perspective schematic view of a polymer substrate plate having an imitating (faux) natural material-pattern surface in accordance with a first preferred embodiment of the present invention.

FIG. 3 is a flow chart of a manufacturing method of polymer substrate plate having an imitating (faux) natural material-pattern surface in accordance with a preferred embodiment of the present invention.

FIG. 4 is a block diagram of a polymer substrate plate having an imitating (faux) natural material-pattern surface in accordance with another preferred embodiment of the present invention.

FIG. 5 is a perspective schematic view of a polymer substrate plate having an imitating (faux) natural material-pattern surface in accordance with a second preferred embodiment of the present invention.

FIG. 6 is a flow chart of a manufacturing method of polymer substrate plate having an imitating (faux) natural material-pattern surface in accordance with another preferred embodiment of the present invention.

FIG. 7 is a perspective schematic view of a polymer substrate plate having an imitating (faux) natural material-pattern surface in accordance with a third preferred embodiment of the present invention.

FIG. 8 is a block diagram of a polymer substrate plate having an imitating (faux) natural material-pattern surface in accordance with another preferred embodiment of the present invention.

FIG. 9 is a flow chart of a manufacturing method of polymer substrate plate having an imitating (faux) natural material-pattern surface in accordance with another preferred embodiment of the present invention.

### DETAILED DESCRIPTION OF THE INVENTION

It is noted that a polymer substrate plate having an imitating (faux) natural material-pattern surface, a structure, a functional device, a manufacturing method and an operational method thereof in accordance with the preferred embodiment of the present invention can be applicable to various heat insulation plate products, various acoustic insulation plate products, various fireproof plate products, various floor tile plate products, various rigid plate products, various mildew proof plate products, or other functional plate products, which are not limitative of the present invention.

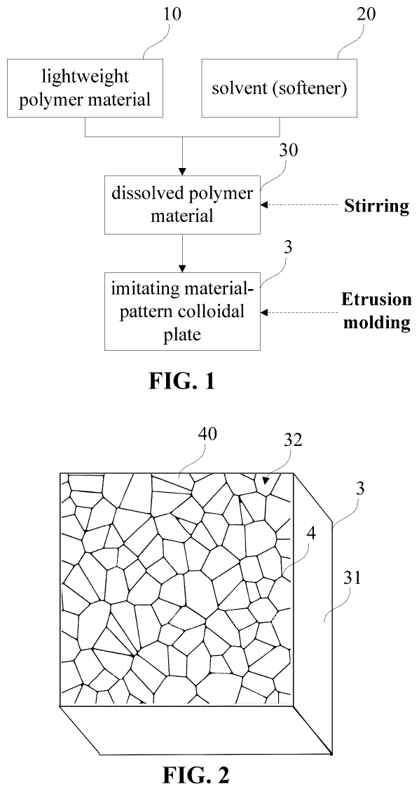

FIG. 1 shows a block diagram of a polymer substrate plate having an imitating natural material-pattern surface in accordance with a preferred embodiment of the present invention. Referring now to FIG. 1, the polymer substrate plate in accordance with the preferred embodiment of the present invention includes at least one lightweight polymer material 10, at least one solvent (e.g., softener or organic solvent) 20, a dissolved polymer material 30 and an imitating material-pattern colloidal plate 3.

With continued reference to FIG. 1, by way of example, the lightweight polymer material 10 can be selected from a similar-polarity polymer material, a dissimilar-polarity polymer material or combination thereof. The similar-polarity polymer material can be suitably processed (e.g., softening, extrusion forming, kneading, stringing or other processing) at room temperature or about 25 degrees Centigrade.

With continued reference to FIG. 1, by way of example, the imitating material-pattern colloidal plate 3 has at least one assembling surface, at least one assembling block or at least one assembling portion. The imitating material-pattern colloidal plate 3 can be selected from an imitating stone furniture plate, an imitating stone decoration plate, an imitating stone board plate, an imitating stone panel plate, an imitating stone floor plate, an imitating stone brick plate, an imitating wooden board plate, an imitating bamboo board plate or combinations thereof.

With continued reference to FIG. 1, by way of example, the imitating material-pattern colloidal plate 3 (shaped imitating material-pattern colloidal plate) further includes at least one glass fiber material or at least one carbon fiber material. Furthermore, the glass fiber material or the carbon fiber material is formed with at least one mesh fiber layer.

FIG. 2 shows a perspective schematic view of a polymer substrate plate having an imitating natural material-pattern surface in accordance with a first preferred embodiment of the present invention, corresponding to the polymer substrate plate shown in FIG. 1. Turning now to FIG. 2, the polymer substrate plate in accordance with the first preferred embodiment of the present invention includes a plate body 31, at least one front surface 32 or at least one rear surface and at least one imitating material grain pattern (imitating stone grain) or at least one imitating 3D material grain pattern, with the polymer substrate plate performed as a raw material plate.

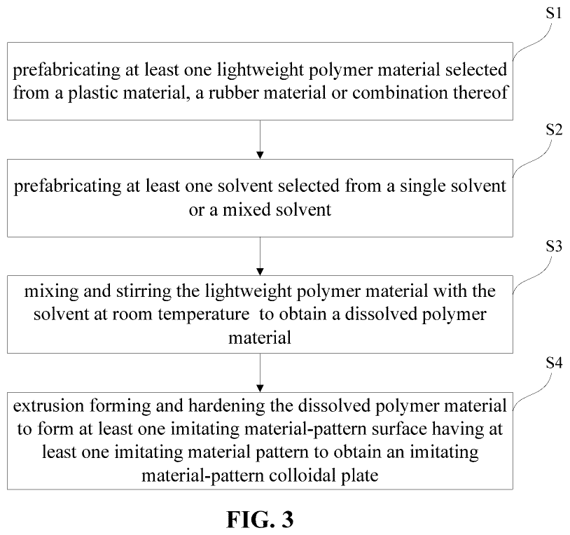

FIG. 3 shows a flow chart of a manufacturing method of polymer substrate plate having an imitating natural material-pattern surface in accordance with a preferred embodiment of the present invention corresponding to the polymer substrate plate shown in FIGS. 1 and 2. Turning now to FIGS. 1, 2 and 3, by way of example, the manufacturing method of polymer substrate plate has a series of procedure (steps S1, S2, S3 and S4) which may be modified according to needs.

Still referring to FIGS. 1, 2 and 3, by way of example, the manufacturing method of polymer substrate plate of the present invention includes the step S1: prefabricating the lightweight polymer material 10 selected from a lightweight plastic material, a lightweight waste plastic material, a lightweight rubber material, a lightweight waste rubber material or combinations thereof in a predetermined unit.

With continued reference to FIGS. 1, 2 and 3, by way of example, the lightweight polymer material 10 can be selected from a plastic fragment material, a waste plastic fragment material, a plastic slice material, a waste plastic slice material, a plastic powder material, a waste plastic powder material or combinations thereof. The lightweight polymer material 10 can be selected from a rubber fragment material, a waste rubber fragment material, a rubber slice material, a waste rubber slice material, a rubber powder material, a waste rubber powder material or combinations thereof.

With continued reference to FIGS. 1, 2 and 3, by way of example, the lightweight polymer material 10 can be dissolved in solvents or organic solvents, with the lightweight polymer material 10 selected from ABS (acrylonitrile butadiene styrene) materials, PC (polycarbonate) materials, PMMA (poly (methyl methacrylate)) materials, PS (polystyrene) materials, TPEQ materials or combinations thereof.

Still referring to FIGS. 1, 2 and 3, by way of example, the manufacturing method of polymer substrate plate of the present invention further includes the step S2: prefabricating the solvent 20 (i.e., softener agent) selected from a single solvent or a mixed solvent comprising a plurality of functional solvents in a predetermined unit.

With continued reference to FIGS. 1, 2 and 3, by way of example, the solvent 20 can be selected from a softener agent, with the softener agent of solvent 20 being selected from acetone, ethyl acetate, butyl acetate or combinations thereof.

With continued reference to FIGS. 1, 2 and 3, by way of example, according to different needs of lightweight polymer material 10, the solvent 20 can be prefabricated with a ratio of single solvent to mixed solvent to provide various material characteristics and functions of the imitating material-pattern colloidal plate 3, with acetone (0 wt %-40 wt %), ethyl acetate (0 wt %-40 wt %) or butyl acetate (0 wt %-40 wt %).

Still referring to FIGS. 1, 2 and 3, by way of example, the manufacturing method of polymer substrate plate of the present invention further includes the step S3: mixing and stirring the lightweight polymer material 10 with the solvent 20 at room temperature (about 25° C. or other suitable temperatures) for energy saving to obtain the dissolved polymer material 30 (mixed polymer material) which is a homogenous colloidal solution material still having the same molecular structure of polymer.

Still referring to FIGS. 1, 2 and 3, by way of example, the manufacturing method of polymer substrate plate of the present invention further includes the step S4: at room temperature (about 25° C. or other suitable temperatures) extrusion forming, kneading and stringing the dissolved polymer material 30 (mixed polymer material) in an extrusion roller or forming machine to form at least one imitating material-pattern surface 40, and hardening and grafting the it at room temperature (about 25° C. or other suitable temperatures) for energy saving to obtain an imitating material-pattern colloidal plate 3 or a shaped imitating material-pattern colloidal plate (e.g., slice, block or others), as best shown in FIGS. 1 and 2, with the imitating material-pattern surface 40 having at least one imitating material grain pattern or at least one imitating 3D material grain pattern.

With continued reference to FIGS. 1, 2 and 3, by way of example, the imitating material-pattern surface 40 of imitating material-pattern colloidal plate 3 (shaped imitating material-pattern colloidal plate) has an extruded 3D surface 4 on the front surface 32 or other suitable surfaces (e.g., rear surface), as best shown in FIG. 2.

With continued reference to FIGS. 1, 2 and 3, by way of example, the imitating material-pattern surface 40 can be selected from an imitating sedimentary rock surface, an imitating granite surface, an imitating marble surface, an imitating dolomite surface, an imitating wooden board plate, an imitating bamboo board plate or combinations thereof. The imitating material grain pattern or the imitating 3D material grain pattern can be selected from an imitating sedimentary rock grain pattern, an imitating granite grain pattern, an imitating marble grain pattern, an imitating dolomite grain pattern, an imitating wooden grain pattern, an imitating bamboo grain pattern or combinations thereof.

With continued reference to FIGS. 1, 2 and 3, by way of example, the dissolved polymer material 30 (mixed polymer material) further is added with at least one functional material, with the functional material selected from a foaming material, a foaming aid agent material, a processing agent material, a fireproof material, a pigment material or combinations thereof.

With continued reference to FIGS. 1, 2 and 3, by way of example, the foaming aid agent material can be selected from stearic acid (e.g., magnesium stearate, zinc stearate or calcium stearate), talcum powder, calcium carbonate or other foaming aid agent materials, with one or more foaming aid agent materials can be added to the dissolved polymer material 30 (mixed polymer material).

With continued reference to FIGS. 1, 2 and 3, by way of example, the foaming aid agent material (e.g., zinc stearate or zinc oxide) provides a functional improvement of a degree of liquidity in the dissolved polymer material 30 (mixed polymer material) for aiding in a demolding operation. The foaming aid agent material (e.g., talcum powder) also provides weak interaction among materials for generating hatching points. The foaming aid agent material also provides an improvement in orders of crystallization of the dissolved polymer material 30 (mixed polymer material) for intensifying a strength of imitating material-pattern colloidal plate 3.

With continued reference to FIGS. 1, 2 and 3, by way of example, the imitating material-pattern colloidal plate 3 (shaped imitating material-pattern colloidal plate) can be provided as an imitating material semi-finished plate which is further processed in a foaming procedure with a softener agent to obtain a softened imitating material-pattern colloidal plate.

Furthermore, by way of example, after evaporating or removing the solvent 20 from the imitating material-pattern colloidal plate 3, the colloidal material can be initially hardened to form a raw material plate (e.g., various solid boards or plates) as a semi-finished plate or product.

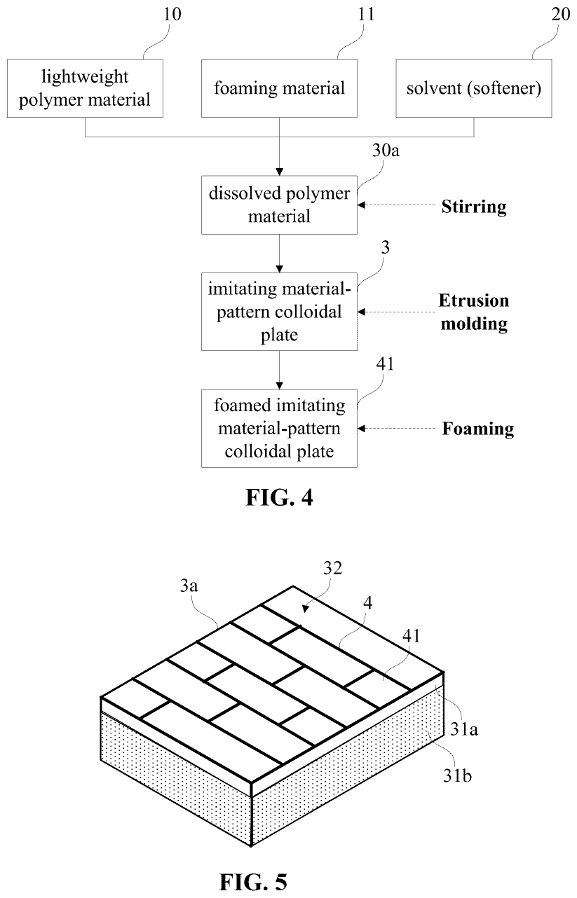

FIG. 4 shows a block diagram of a polymer substrate plate having an imitating natural material-pattern surface in accordance with another preferred embodiment of the present invention corresponding to the polymer substrate plate shown in FIG. 1. Referring now to FIG. 4, the polymer substrate plate in accordance with the preferred embodiment of the present invention includes at least one lightweight polymer material 10, at least one foaming material 11 (or foaming agent), at least one solvent (e.g., softener or organic solvent) 20, a dissolved polymer material 30a, a multi-layer complex imitating material-pattern colloidal plate 3a and a foamed imitating material-pattern colloidal plate 41.

With continued reference to FIG. 4, by way of example, the foaming material 11 (e.g., chemically or physically foaming agent) can selectively has an amount of 0.2 wt % to 5.0 wt %, with the foaming material 11 (or foaming agent) selected from a wet or dry foaming material, with the wet foaming material selected from methylene chloride or acetone, with the dry foaming material selected from inorganic foaming agents (e.g., azodiformamide (ADA), azobisisobutyronitrile (AIBN) or other foaming agents) or chemical foaming agents (ammonium bicarbonate, ammonium carbonate, sodium bicarbonate, or other organic foaming agents). Further, a semi-finished plate or product of the multi-layer complex imitating material-pattern colloidal plate 3a can be foamed at a predetermined temperature.

With continued reference to FIG. 4, by way of example, the foaming aid material can have an amount of 5.0 wt % to 55.0 wt % in the dissolved polymer material 30a with respect to those of lightweight polymer material 10 (e.g., hard plastic structural material) and solvent 20. Further, the foaming aid material is selected from stearic acid (e.g., magnesium stearate, zinc stearate or calcium stearate), talcum powder or calcium carbonate.

With continued reference to FIG. 4, by way of example, the foaming material 11 (or foaming agent) can be selectively added to a part or whole of the imitating material-pattern colloidal plate 3. In a preferred embodiment, when one layer of imitating material-pattern colloidal plate 3 is added with the foaming material 11 (or foaming agent), it can produce a double-layer plate, as shown in FIG. 5, or a multi-layer sandwiched plate (e.g., foamed layer sandwiched between two layers) or other multi-layer plates.

FIG. 5 shows a perspective schematic view of a polymer substrate plate having an imitating natural material-pattern surface in accordance with a second preferred embodiment of the present invention corresponding to the polymer substrate plate shown in FIG. 2. Turning now to FIG. 5, by way of example, in comparison with the first embodiment, the polymer substrate plate of the second preferred embodiment of the present invention has a structure, including a first plate layer 31a and a second plate layer 31b, with the second plate layer 31b provided as a foamed colloidal plate layer, with the first plate layer 31a and the second plate layer 31b forming a complex imitating material-pattern colloidal plate as a double-layer plate.

With continued reference to FIG. 5, by way of example, in comparison with the first embodiment, the structure of polymer substrate plate of the second preferred embodiment includes at least one imitating material grain pattern (imitating brick wall grain pattern or 3D material grain pattern) or other imitating stone grain patterns.

With continued reference to FIG. 5, by way of example, according to needs, the first plate layer 31a and the second plate layer 31b or other plate layers can be processed to form another multi-layer complex imitating material-pattern plate by using the solvent 20, organic solvent or equivalent organic solvent material.

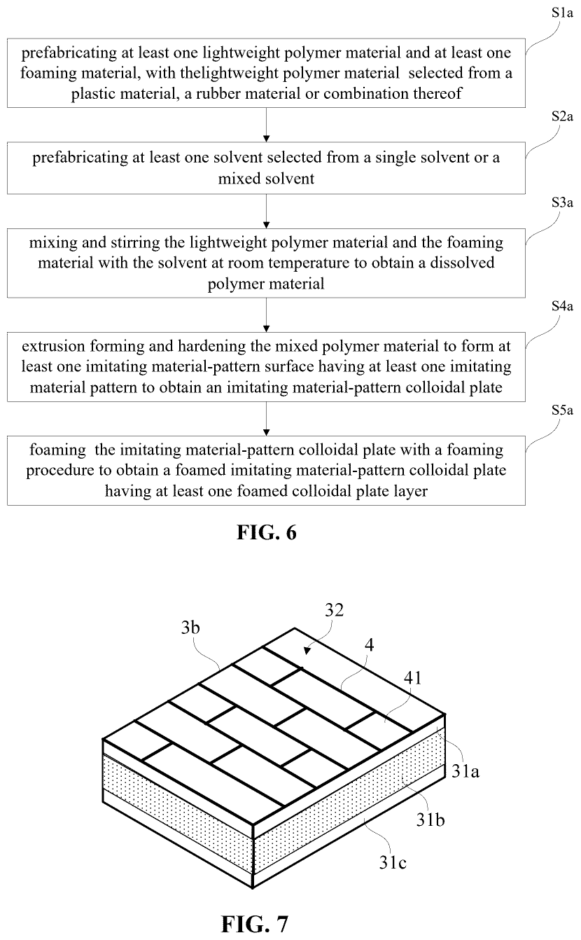

FIG. 6 shows a flow chart of a manufacturing method of polymer substrate plate having an imitating natural material-pattern surface in accordance with another preferred embodiment of the present invention corresponding to the polymer substrate plate shown in FIGS. 4 and 5. Turning now to FIGS. 4, 5 and 6, by way of example, the manufacturing method of polymer substrate plate has a series of procedure (steps S1, S2, S3, S4 and S5) which may be modified according to needs.

Still referring to FIGS. 4, 5 and 6, by way of example, the manufacturing method of polymer substrate plate of the present invention includes the step S1a: prefabricating the lightweight polymer material 10 with the foaming material 11 (or foaming agent), with the lightweight polymer material 10 selected from a lightweight plastic material, a lightweight waste plastic material, a lightweight rubber material, a lightweight waste rubber material or combinations thereof.

Still referring to FIGS. 4, 5 and 6, by way of example, the manufacturing method of polymer substrate plate of the present invention further includes the step S2a: prefabricating the solvent 20 (i.e., softener agent) selected from a single solvent or a mixed solvent comprising a plurality of functional solvents.

Still referring to FIGS. 4, 5 and 6, by way of example, the manufacturing method of polymer substrate plate of the present invention further includes the step S3a: mixing and stirring the lightweight polymer material 10 and the foaming material 11 (or foaming agent) with the solvent 20 at room temperature (about 25° C. or other suitable temperatures) for energy saving to obtain the dissolved polymer material 30a (mixed polymer material) which is a homogenous colloidal solution material still having the same molecular structure of polymer.

Still referring to FIGS. 4, 5 and 6, by way of example, the manufacturing method of polymer substrate plate of the present invention further includes the step S4a: at room temperature (about 25° C. or other suitable temperatures) extrusion forming the dissolved polymer material 30a (mixed polymer material) in an extrusion roller or forming machine to form at least one imitating material-pattern surface, and hardening and grafting the it at room temperature (about 25° C. or other suitable temperatures) for energy saving to obtain an imitating material-pattern colloidal plate 3 or a shaped imitating material-pattern colloidal plate (e.g., slice, block or others), as best shown in FIG. 4, or an multi-layer complex imitating material-pattern colloidal plate 3a, as best shown in FIG. 5, with the imitating material-pattern surface having at least one imitating material grain pattern or at least one imitating 3D material grain pattern.

Still referring to FIGS. 4, 5 and 6, by way of example, the manufacturing method of polymer substrate plate of the present invention further includes the step S5a: processing the imitating material-pattern colloidal plate 3, as best shown in FIG. 4, or multi-layer complex imitating material-pattern colloidal plate 3a, as best shown in FIG. 5, in a foaming procedure at a predetermined temperature (about 120° C., 180° C. or other temperatures) for a predetermined processing time (about 15 or 40 minutes or other processing time) to obtain a foamed imitating material-pattern colloidal plate 41 having at least one foamed plate layer.

FIG. 7 shows a perspective schematic view of a polymer substrate plate having an imitating natural material-pattern surface in accordance with a third preferred embodiment of the present invention corresponding to the polymer substrate plate shown in FIG. 5. Turning now to FIG. 5, by way of example, in comparison with the second embodiment, the polymer substrate plate of the third preferred embodiment of the present invention has a structure, including a first plate layer 31a, a second plate layer 31b and a third plate layer 31c, with the second plate layer 31b provided as a foamed colloidal plate layer, with the first plate layer 31a, the second plate layer 31b and the third plate layer 31c forming a complex imitating material-pattern colloidal plate as a multi-layer sandwiched plate.

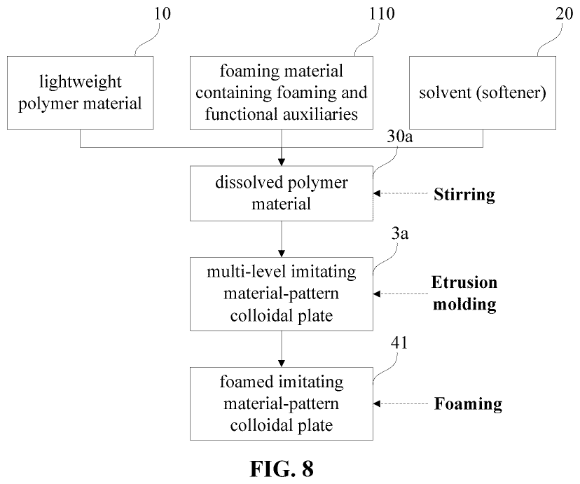

FIG. 8 shows a block diagram of a polymer substrate plate having an imitating natural material-pattern surface in accordance with another preferred embodiment of the present invention. corresponding to the polymer substrate plate shown in FIG. 4. Referring now to FIG. 8, the polymer substrate plate in accordance with the preferred embodiment of the present invention includes at least one lightweight polymer material 10, at least one foaming material containing foaming and functional auxiliaries 110, at least one solvent (e.g., softener or organic solvent) 20, a dissolved polymer material 30a, a multi-layer complex imitating material-pattern colloidal plate 3a and a foamed imitating material-pattern colloidal plate 41.

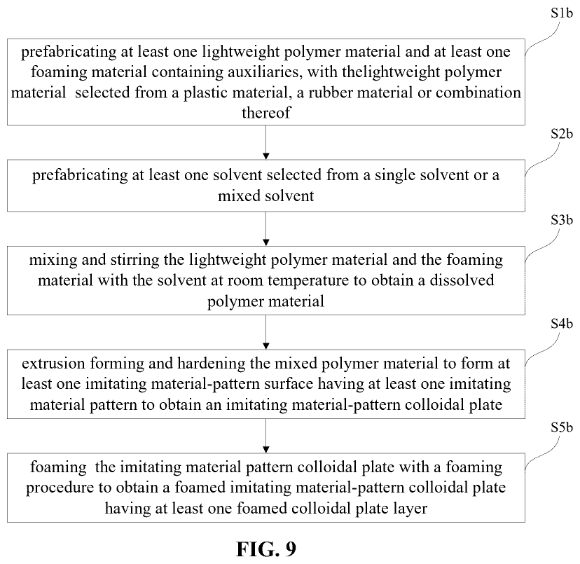

FIG. 9 shows a flow chart of a manufacturing method of polymer substrate plate having an imitating natural material-pattern surface in accordance with another preferred embodiment of the present invention corresponding to the polymer substrate plate shown in FIG. 8. Turning now to FIGS. 8 and 9, by way of example, the manufacturing method of polymer substrate plate has a series of procedure (steps S1, S2, S3, S4 and S5) which may be modified according to needs.

Still referring to FIGS. 8 and 9, by way of example, the manufacturing method of polymer substrate plate of the present invention includes the step S1b: prefabricating the lightweight polymer material 10 with the foaming material containing foaming and functional auxiliaries 110, with the lightweight polymer material 10 selected from a lightweight plastic material, a lightweight waste plastic material, a lightweight rubber material, a lightweight waste rubber material or combinations thereof.

Still referring to FIGS. 8 and 9, by way of example, the manufacturing method of polymer substrate plate of the present invention further includes the step S2b: prefabricating the solvent 20 (i.e., softener agent) selected from a single solvent or a mixed solvent comprising a plurality of functional solvents.

Still referring to FIGS. 8 and 9, by way of example, the manufacturing method of polymer substrate plate of the present invention further includes the step S3b: mixing and stirring the lightweight polymer material 10 and the foaming material containing foaming and functional auxiliaries 110 with the solvent 20 at room temperature (about 25° C. or other suitable temperatures) for energy saving to obtain the dissolved polymer material 30a (mixed polymer material) which is a homogenous colloidal solution material still having the same molecular structure of polymer.

Still referring to FIGS. 8 and 9, by way of example, the manufacturing method of polymer substrate plate of the present invention further includes the step S4b: at room temperature (about 25° C. or other suitable temperatures) extrusion forming the dissolved polymer material 30a (mixed polymer material) in an extrusion roller or forming machine to form at least one imitating material-pattern surface, and hardening and grafting the it at room temperature (about 25° C. or other suitable temperatures) for energy saving to obtain an imitating material-pattern colloidal plate 3 or a shaped imitating material-pattern colloidal plate (e.g., slice, block or others), as best shown in

FIG. 4, or an multi-layer complex imitating material-pattern colloidal plate 3a, as best shown in FIGS. 5 and 7, with the imitating material-pattern surface having at least one imitating material grain pattern or at least one imitating 3D material grain pattern.

Still referring to FIGS. 8 and 9, by way of example, the manufacturing method of polymer substrate plate of the present invention further includes the step S5b: processing the imitating material-pattern colloidal plate 3, as best shown in FIG. 4, or multi-layer complex imitating material-pattern colloidal plate 3a, as best shown in FIGS. 5 and 7, in a foaming procedure at a predetermined temperature (about 120° C., 180° C. or other temperatures) for a predetermined processing time (about 15 or 40 minutes or other processing time) to obtain a foamed imitating material-pattern colloidal plate 41 having at least one foamed plate layer.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A polymer substrate plate comprising:
at least one lightweight polymer material selected from a plastic material, a rubber material or combination thereof;
at least one solvent selected from a single solvent or a mixed solvent;
a mixed polymer material formed as a dissolved polymer material by mixing and stirring the lightweight polymer material with the solvent at room temperature;
an imitating material-pattern colloidal plate formed by extrusion forming and hardening the mixed polymer material to obtain at least one imitating material-pattern surface; and
at least one imitating material pattern formed on the at least one imitating material-pattern surface provided on the imitating material-pattern colloidal plate.

2. The polymer substrate plate as defined in claim 1, wherein the imitating material-pattern surface is selected from an imitating sedimentary rock surface, an imitating granite surface, an imitating marble surface, an imitating dolomite surface, an imitating wooden board plate, an imitating bamboo board plate or combinations thereof.

3. The polymer substrate plate as defined in claim 1, wherein the imitating material-pattern colloidal plate has at least one assembling surface, at least one assembling block or at least one assembling portion.

4. The polymer substrate plate as defined in claim 1, wherein the imitating material-pattern colloidal plate is selected from an imitating stone furniture plate, an imitating stone decoration plate, an imitating stone board plate, an imitating stone panel plate, an imitating stone floor plate, an imitating stone brick plate, an imitating wooden board plate, an imitating bamboo board plate or combinations thereof.

5. The polymer substrate plate as defined in claim 1, wherein the imitating material-pattern colloidal plate is performed as an imitating material semi-finished plate.

6. The polymer substrate plate as defined in claim 1, wherein the plastic material is selected from a plastic fragment material, a waste plastic fragment material, a plastic slice material, a waste plastic slice material, a plastic powder material, a waste plastic powder material or combinations thereof.

7. The polymer substrate plate as defined in claim 1, wherein the rubber material is selected from a rubber fragment material, a waste rubber fragment material, a rubber slice material, a waste rubber slice material, a rubber powder material, a waste rubber powder material or combinations thereof.

8. The polymer substrate plate as defined in claim 1, wherein the plastic material or the rubber material is selected from a solvent-soluble material, an organic-solvent-soluble material or combination thereof.

9. The polymer substrate plate as defined in claim 1, wherein the mixed polymer material is added with at least one functional material.

10. The polymer substrate plate as defined in claim 9, wherein the at least one functional material is selected from a foaming material, a foaming aid agent material, a processing agent material, a fireproof material, a pigment material or combinations thereof.

11. A manufacturing method of a polymer substrate plate comprising:
prefabricating at least one lightweight polymer material selected from a plastic material, a rubber material or combination thereof;
prefabricating at least one solvent selected from a single solvent or a mixed solvent;
mixing and stirring the lightweight polymer material with the solvent at room temperature to obtain a mixed polymer material as a dissolved polymer material; and
extrusion forming and hardening the mixed polymer material to form at least one imitating material-pattern surface having at least one imitating material pattern to obtain an imitating material-pattern colloidal plate.

12. The method as defined in claim 11, wherein the imitating material-pattern colloidal plate further includes at least one glass fiber material or at least one carbon fiber material.

13. The method as defined in claim 11, wherein the at least one glass fiber material or the at least one carbon fiber material is formed with at least one mesh fiber layer.

14. The method as defined in claim 11, wherein the imitating material-pattern colloidal plate is provided as an imitating material semi-finished plate which is further processed in a foaming procedure to obtain a foamed imitating material-pattern colloidal plate.

15. The method as defined in claim 11, wherein the imitating material-pattern colloidal plate is provided as an imitating material semi-finished plate which is further processed in a foaming procedure with a softener agent to obtain a softened imitating material-pattern colloidal plate.

16. The method as defined in claim 11, wherein the at least one solvent is provided to dissolve at least one part of the plastic material or the rubber material to form at least one polymer colloid.

17. The method as defined in claim 11, wherein the at least one polymer colloid is provided to adhere and graft among the plastic material, the rubber material or both.

18. The method as defined in claim 11, wherein the imitating material-pattern colloidal plate has an extruded 3D surface.
